(19) United States
(12) Patent Application Publication
(10) Pub. No.: US 2022/0092498 A1
(43) Pub. Date: Mar. 24, 2022

(54) VIRTUAL REALITY SIMULATION ACTIVITY SCHEDULING

(71) Applicant: International Business Machines Corporation, Armonk, NY (US)

(72) Inventors: Subha Kiran Patnaikuni, Visakhapatnam (IN); Sarbajit K. Rakshit, Kolkata (IN)

(21) Appl. No.: 17/030,433

(22) Filed: Sep. 24, 2020

(51) Int. Cl. G06Q 10/06; G06Q 10/10; G06T 19/00; G06K 9/00

(52) U.S. Cl. CPC G06Q 10/06314; G06Q 10/06398; G06K 9/00671; G06Q 10/103; G06T 19/003; G06Q 10/063116

(57) ABSTRACT

Embodiments of the present invention provide a computer system a computer program product, and a method that comprises generating a virtual environment for a plurality of users based on a stored activity; identifying multiple contextual factors associated with an interaction for each respective user in the plurality of users within the generated virtual environment; assessing the interaction for each respective user in the plurality of users based on the identified multiple contextual factors associated with the stored activity within the generated virtual environment; determining a deficiency in the assessed interaction of at least one user in the plurality of users based on a performance analysis of the stored activity within the generated virtual environment; and dynamically generating a calendar invitation for the plurality of users for a future activity associated with the determined deficiency based on a predetermined threshold of performance within the generated virtual environment.

### BACKGROUND

The present invention relates generally to the field of virtual reality technology, and more specifically generating an adaptive virtual reality environment.

Global positioning system (“GPS”) is a satellite-based navigation system. This global navigation satellite systems provides geolocation and time information to a GPS receiver anywhere on or near the Earth where there is an unobstructed line of sight to four or more GPS satellites. Obstacles such as mountains and buildings block the relatively weak GPS signals. The GPS does not require the user to transmit any data, and it operates independently of any telephonic or interne reception, though these technologies can enhance the usefulness of the GPS positioning information. The GPS provides critical positioning capabilities to military, civil, and commercial users around the world.

Virtual reality is a simulated experience that can be similar to or completely different from the real world. Applications of virtual reality can include entertainment (i.e. video games) and educational purposes (i.e. medical or military training). Other, distinct types of virtual reality style technology include augmented reality and mixed reality. Currently standard virtual reality systems use either virtual reality headsets or multi-projected environments to generate realistic images, sounds and other sensations that simulate a user's physical presence in a virtual environment. A person using virtual reality equipment is able to look around the artificial world, move around in it, and interact with virtual features or items. The effect is commonly created by virtual reality headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

### SUMMARY

Embodiments of the present invention provide a computer system a computer program product, and a method that comprises generating a virtual environment for a plurality of users based on a stored activity; identifying multiple contextual factors associated with an interaction for each respective user in the plurality of users within the generated virtual environment; assessing the interaction for each respective user in the plurality of users based on the identified multiple contextual factors associated with the stored activity within the generated virtual environment; determining a deficiency in the assessed interaction of at least one user in the plurality of users based on a performance analysis of the stored activity within the generated virtual environment; and dynamically generating a calendar invitation for the plurality of users for a future activity associated with the determined deficiency based on a predetermined threshold of performance within the generated virtual environment.

### BRIEF DESCRIPTION OF THE DRAWINGS

FIG. 1 is a functional block diagram depicting an environment with a computing device connected to or in communication with another computing device, in accordance with at least one embodiment of the present invention;

FIG. 2 is a flowchart illustrating operational steps for dynamically generating an invitation based on an interaction of a user within a virtual reality environment, in accordance with at least one embodiment of the present invention;

FIG. 3 is a flowchart illustrating operational steps for assessing a deficiency within the interaction of the user within a virtual reality environment, in accordance with at least one embodiment;

FIG. 4 is an exemplary diagram depicting the dynamic generation of an invitation based on the interaction of the user within a virtual environment, in accordance with at least one embodiment of the present invention; and

FIG. 5 depicts a block diagram of components of computing systems within a computing display environment of FIG. 1, in accordance with an embodiment of the present invention.

### DETAILED DESCRIPTION

Embodiments of the present invention recognize a need for an improvement to current virtual reality technology systems providing a user steps to complete ongoing and future activities that the user does not know how to start or complete. Embodiments of the present invention provide systems, methods, and computer program products for improving existing virtual reality technologies. Currently, virtual reality (“VR”) provide virtual environments that are stored in the virtual reality device, which has repetitive outcomes due to the environments being pre-conceived and static. Embodiments of the present invention improve these VR technologies by generating a shared virtual environment for multiple users, learning elicited responses from interactions of multiple users with the generated virtual environment, and predicting future user behavior based on learned elicited responses for each respective user in the multiple users. Embodiments of the present invention assess interactions within the generated virtual environment for each user by continually observing movements of the user within the generated virtual environment; identifying contextual factors within the generated virtual environment, assigning values to each identified contextual factor, calculating an overall score by summing the assigned values of the identified contextual factors, and in response to the calculated overall score meeting or exceeding a predetermined threshold value, automatically transmitting an invitation to a different user to interact with the generated virtual environment at a fixed time in the future. In this embodiment, the program 104 defines contextual factors as any factor that has an impact or an effect on a performance of each user of the simulated activity within the generated virtual environment. Examples of these contextual factors are angle, speed, direction, movement, duration of an activity, location of activity, complexity of an activity, and a need for collaboration of an activity. Embodiments of the present invention determine a deficiency associated with the interaction of each user based on the assessment of the interaction of each user by analyzing the assessed interaction for each user with the generated virtual environment and comparing the interactions for each user with a predicted performance. In response to determining a deficiency associated with the interaction of a user, embodiments of the present invention generate an invitation to a future virtual activity by selecting at least one different user from the plurality of users. Embodiments of the present invention generate an invitation for the entire plurality of users based on availability or contingency and removes unavailable assistance users from the generated invitation.

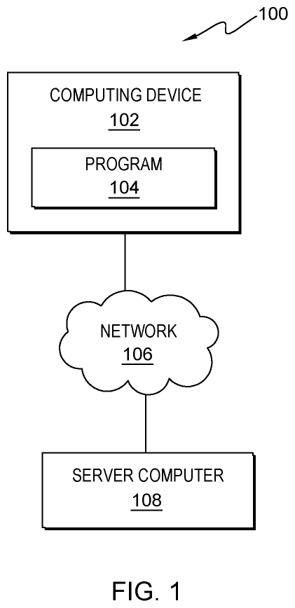

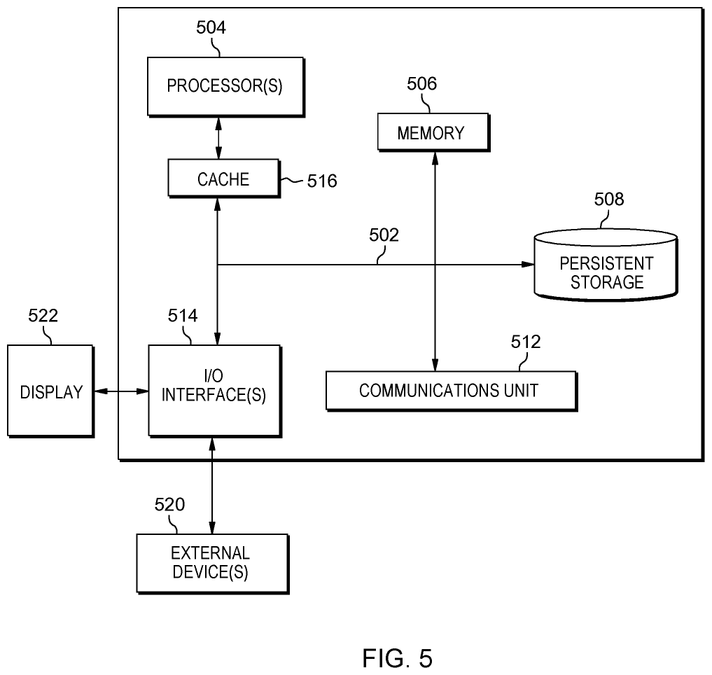

FIG. 1 is a functional block diagram of a computing environment 100 in accordance with an embodiment of the present invention. The computing environment 100 includes a computing device 102 and a server computing device 108. The computing device 102 and the server computing device 108 may be desktop computers, laptop computers, specialized computer servers, smart phones, wearable technology, or any other computing devices known in the art. In certain embodiments, the computing device 102 and the server computing device 108 may represent computing devices utilizing multiple computers or components to act as a single pool of seamless resources when accessed through a network 106. Generally, the computing device 102 and the server computing device 108 may be representative of any electronic devices, or a combination of electronic devices, capable of executing machine-readable program instructions, as described in greater detail with regard to FIG. 5.

The computing device 102 may include a program 104. The program 104 may be a stand-alone program on the computing device 102. In another embodiment, the program 104 may be stored on a server computing device 108. In this embodiment, the program 104 generates a virtual environment for multiple users to simulate future activities to be performed for multiple users by accessing a database of stored activities. In this embodiment, the program 104 dynamically identifies multiple factors of the simulated future activity by observing movements of each individual and comparing those observed movements to expected movements associated with the simulated future activity to assess a predetermined interaction pattern of each individual. This predetermined interaction pattern is defined as a decision-making process for each user and is determined by continually observing interactions for that respective user with multiple simulated environments. In this embodiment, the program 104 automatically generates a detailed report for each individual by assigning values to each identified factor and prioritizes the multiple factors using a virtual simulation, where the more critical steps of the simulated activity are given a higher priority order due to its higher assigned value. In this embodiment, the program 104 defines a critical step as a step that requires multiple actors to perform the activity. An example of a critical step would be a simulated activity for a user to perform a set-up and spike in volleyball because at least one user performs the set and another user performs the spike of the volleyball. In this embodiment, the program 104 generates a calendar for each respective user by receiving input from a user, and automatically modifying the calendar to reflect the prioritized factors of the simulated activity, in the event that the simulated activity presents a change to a previously scheduled event.

In another embodiment and in response to observed movements failing to match a pre-stored activity, the program 104 automatically transmits a notification to the user to request additional information regarding the activity within the virtual environment and stores these activities for future use to learn additional activities. In this embodiment, the program 104 defines matching observed movements to pre-stored activities by determining that a number of observed movements meet or exceed the number of movements associated with the performance of the pre-stored activity. In this embodiment, the program 104 automatically transmits notifications to computing devices 102 associated with other users to request assistance with the completion of an activity based on the user's interaction with the virtual environment.

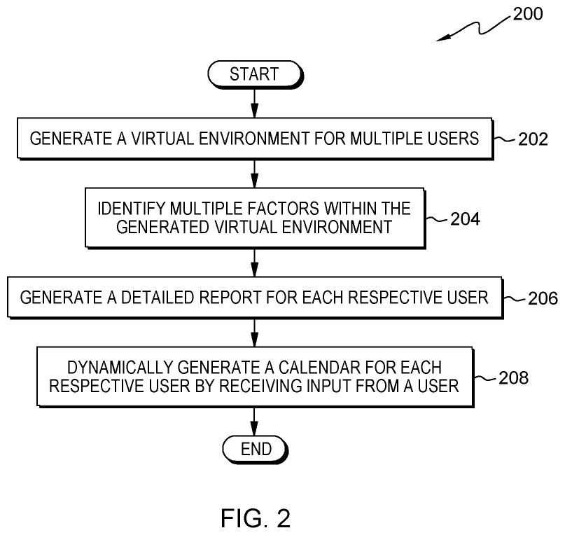

FIG. 2 is a flowchart 200 illustrating operational steps for dynamically scheduling activities based on an interaction with a virtual reality environment, in accordance with at least one embodiment of the present invention.

In step 202, program 104 generates a virtual environment for multiple users. In this embodiment, program 104 generates a virtual environment for multiple users by accessing a database of stored activities for the interaction of each user. In this embodiment, the program 104 simulates an activity within the generated virtual environment that is observed and interacted with by multiple users simultaneously. For example, the program 104 generates a virtual baseball game environment focused on a batter at bat versus a pitcher, a pitcher on the mound versus a batter, and a catcher behind a batter determining pitches. In another embodiment, program 104 generates a virtual environment fort a single user at a given time.

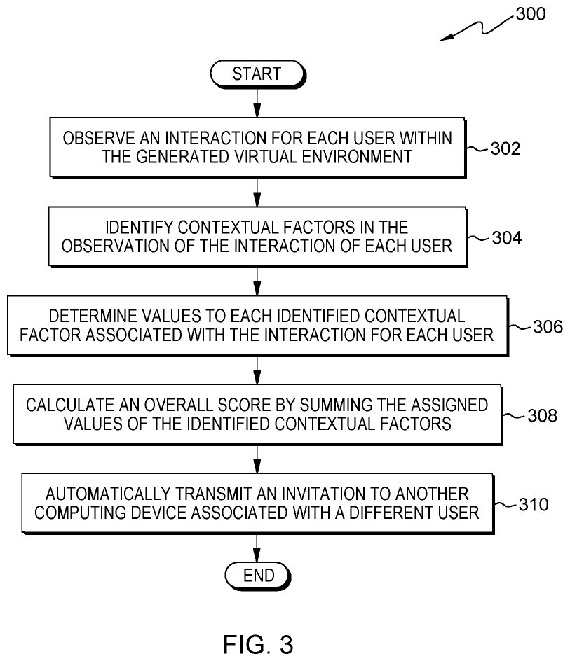

In step 204, the program 104 assesses an interaction for each user with the simulation associated with the generated virtual environment. In this embodiment, the program 104 assesses interactions for each user within the simulation by observing an interaction for each user, identifying contextual factors within the generated virtual environment, assigning values to each identified contextual factor, calculating an overall score by summing the assigned values of the identified contextual factors, and in response to the calculated overall score meeting or exceeding a predetermined threshold value, automatically transmitting an invitation to a different user to interact with the generated virtual environment at a fixed time in the future. In this embodiment, the program 104 defines the different user as a second user to interact with the generated virtual environment in conjunction with a first user. This step will be further explained in FIG. 3. In this embodiment, the program 104 assesses an interaction for each user with the simulation by continually observing interactions for each respective user with the generated virtual environment, comparing the observation of an interaction for each respective user with the generated virtual environment to the database of stored activities, and identifying contextual factors that are common between the observation of the interaction and the generated virtual environment to assess an involvement or level of skill for each respective user. In this embodiment, the program 104 continually observes interactions for each user using sensor devices with the generated virtual environment. For example, the program 104 continually observes the virtual batting practice of the batter using computer vision devices. In this embodiment, the program 104 receives opt-in/opt-out permission from a user to continually observe a user within the generated virtual environment. In this embodiment, the user may terminate the observation with the generated virtual environment at any time.

In this embodiment, the program 104 defines the identified contextual factors as data that has an impact on an interaction for a user with the generated virtual environment. In this embodiment, examples of identified contextual factors are the type of simulated activity, volume of movements associated with the simulated activity, predicted results, and skills associated with the simulated activity. For example, the program 104 assesses the performance of the batter within the generating batting simulation, where the batter has two strikes and three balls within the virtual batting simulation environment by observing the movements of the pitcher and the batter, calculating a performance score by summing assigned values associated with the performance of the batter within the simulation, and in response to the performance score being lower than the threshold, automatically transmitting an calendar event for the batter to simulate an additional batting practice two days in the future.

In step 206, the program 104 determines a deficiency within an interaction for each user with the generated virtual environment. In this embodiment, the program 104 determines a deficiency for each user by analyzing the assessment an interaction for each user with the generated virtual environment and comparing the interactions for each user with a predicted performance. In this embodiment, the program 104 predicts a performance by analyzing previous assessments associated with the interaction for each user and generating a prediction based on the analysis of the previous assessments associated with the interaction of each user. For example, the program 104 analyzes that user A scores a touchdown in each previous assessment within the generated virtual environment, then the program 104 predicts that user A scores a touchdown in every assessment within the generated virtual environment. In this embodiment, the program 104 defines the predicted performance as a pre-stored analysis associated with each activity that the is generated within the virtual environment. In this embodiment, the program 104 generates a prediction associated with the performance prior to the simulated activity occurring; stores the generated prediction within the server computing device 108; and in response to the user preforming the simulated activity within the generated virtual environment, retrieving the generated prediction from the server computing device 108 for a comparison with an assessment of the interaction for each user. In this embodiment, the program 104 uses the predicted performance as a basis for determining the predetermined threshold value associated with the identified contextual factors and calculated overall score based on the identified contextual factors. In this embodiment, the program 104 determines that there is no deficiency within the interaction of each user in response to the calculated overall score associated with the interaction of each user with the generated virtual environment failing to meet or exceed the predetermined threshold value. In another embodiment, the program 104 generates a detailed report for each respective user based on the determined deficiency associated with the interaction for each user with the virtual environment. For example, the program 104 determines there is a seven degree angle displacement of the pitching elbow at the moment the pitcher releases the ball at the end of the pitching motion in the virtual baseball environment based on the calculated score for each user meeting or exceeding the predetermined threshold value associated with the virtual baseball environment for each user.

In step 208, the program 104 dynamically generates an invitation for each respective user by receiving input from a user. In this embodiment and in response to determining a deficiency associated with the interaction for each user with the generated virtual environment, the program 104 dynamically generates a calendar invitation for each respective user based on received additional input from a user using haptic sensors in communication within the generated virtual environment. In this embodiment, the program 104 defines the received additional input from the user as a confirmation of the calendar invitation information. For example, the received additional input from the user occurs when the user confirms the invitation details via a haptic sensor within the generated virtual environment. In this embodiment, the program 104 receives input from each user while the respective user is interacting with the generated virtual environment. In this embodiment, the program 104 receives input form the user while interacting with the virtual environment through haptic sensors. In this embodiment, the program 104 generates the calendar invitation for each respective user by compiling the received input from the user through the haptic sensors while the user is interacting with the generated virtual environment. In this embodiment, the program 104 dynamically generates an invitation and transmits via the network 106 an invitation to another computing device 102 associated with a different user. In this embodiment, the different user is defined as an assistance user, where the assistance user provides support to each user in the generated virtual environment. In this embodiment, the program 104 dynamically generates an invitation for the assistance user to modify the calculated overall score associated with the interaction for each user with the generated virtual environment based on the generated detail report of prioritized assigned values associated with the identified contextual factors. For example, the program 104 determines the calculated overall score meets or exceeds the predetermined threshold value for the batter within the generated virtual environment, receives input from the haptic sensor associated with the batter to accept an additional virtual batting practice, and dynamically generates a calendar invitation for the batter and a batting coach for a batting practice at a later date due to observing the poor performance of the batter within the simulated virtual environment and receiving feedback from the batter that comprises the batter wanting more practice.

In this embodiment, the program 104 dynamically generates the calendar for multiple users. In this embodiment, the program 104 dynamically generates the calendar for multiple users in response to the observation of the simulated virtual activity and the generated detailed report requiring multiple users to attend an event or meeting to overcome the degree of displacement in the pitching elbow or hip placement of the batting stance of the user within the simulated virtual environment. For example, the program 104 observes and generates a detailed report in response to the pitcher struggling to consistently throw pitches in the strike zone within the simulated virtual environment. In this example, the program 104 dynamically generates a calendar event for the pitcher to continue working on his pitching and automatically sends an invite to the batter that input feedback requesting more batting practice. In another embodiment and in response to receiving input from each user regarding the generated calendar, the program 104 determines a particular virtual environment that is needed for the future activity associated with the generated calendar event. In another embodiment, the program 104 reserves computational resources based on a determination for the further simulated virtual environment. In this embodiment, the program 104 estimates an amount of resource associated with the future simulated activity based on the pre-stored activity information.

FIG. 3 is a flowchart 300 illustration operational steps for assessing an interaction of the user within a generated virtual environment, in accordance with at least one embodiment of the present invention.

In step 302, the program 104 observes an interaction for each user with the generated virtual environment. In this embodiment, the program 104 observes the interaction for each user with the generated virtual environment by continually monitoring movements of the user using sensors within the generated virtual environment. In this embodiment, the program 104 observes the interaction of each user within the virtual environment using sensor devices that transmit data from the virtual environment to a server computing device 108 for analysis at a later period of time. For example, the program 104 uses computer vision to observe the virtual batting practice of the batter within the generated virtual environment. In another embodiment, the program 104 provides a live feed of the interaction of each user within the virtual environment using sensor devices. In this embodiment, the program 104 receives opt-in/opt-out permission from the user in order to continually monitor the movements of the user. In this embodiment, the user may terminate the monitoring at any given time.

In step 304, the program 104 identifies contextual factors in the observation of the interaction for each user. In this embodiment, the program 104 identifies contextual factors by comparing the observation of the interaction of each user to a stored prediction of a simulated activity within the generated virtual environment. For example, the program 104 defines the angle of an elbow of the pitcher at the moment the ball is released as a contextual factor.

In step 306, the program 104 determines values to each identified contextual factor associated with the interaction for each user with the generated virtual environment. In this embodiment, the program 104 determines values for each identified contextual factor proportional to the impact of each identified factor in the performance of the user in the simulated activity within the generated virtual environment. In this embodiment, the program 104 generates a scale for the determined values, where the range of the generated scale is from 1-10. In this embodiment, the lowest value of 1 has the least impact or effect on the performance of the user in the simulated activity, and the highest value of 10 has the highest impact or effect on the performance of the user in the simulated activity. For example, the program 104 determines a value for multiple actions of the batter has an assigned value, where a strike receives has a value of 1, a hit receives a value −2, a pop out receives a value of 2, and a home run receives a value of 4. In this embodiment, the program 104 may determine a maximum value for a specific action within the observation of the interaction of the user with the simulated activity. For example, the program 104 determines a value of 10 for a driver to crash within a racing simulation.

In step 308, the program 104 calculates an overall score by summing the assigned values of the identified contextual factors. In this embodiment, the program 104 calculates an overall score associated with the level of deficiency associated with the interaction of the user by aggregating the assigned values, positive and negative values, to produce an overall score, wherein the calculated overall score indicates the location of the identified contextual factor for the performance of the user on the generated scale of assigned values. For example, the program 104 calculates an overall score for the batting session by summing the values of the strikes, pop-outs, hits, and home runs with a result of 8.

In step 310, the program 104 automatically transmits an invitation to another computing device associated with a different user. In this embodiment and in response to the calculated overall score meeting or exceeding a predetermined threshold value, transmitting an invitation to another computing device associated with a different user to interact with the generated virtual environment. In this embodiment, the different user may be a single user or a group of other users. In another embodiment, the program 104 automatically transmits an invitation to an identified user, where the user is an assistance user. In another embodiment, the program 104 selects at least one assistance user from a plurality of assistance users. In this embodiment, the program 104 selects the assistance user based on a rank associated with the assistance user. In this embodiment, the program 104 assigns a value to an assistance user based on availability, previous rating from other users, and usage of the assistance user. In this embodiment and in response to assigning values to a plurality of assistance users, the program 104 sorts the plurality of assistance users, where the assistance user with the highest value is placed at the highest order and the assistance user with the lowest value is placed at the lowest order for the plurality of assistance users. In another embodiment, the program 104 generates an invitation for the entire plurality of assistance users and based on availability or contingency, removes unavailable assistance users form the generated invitation. In another embodiment, the program 104 generates a calendar notification that is stored on a server computing device 108 associated with the identified user. In this embodiment, the calendar notification details the time, purpose, and participants of the transmitted invitation.

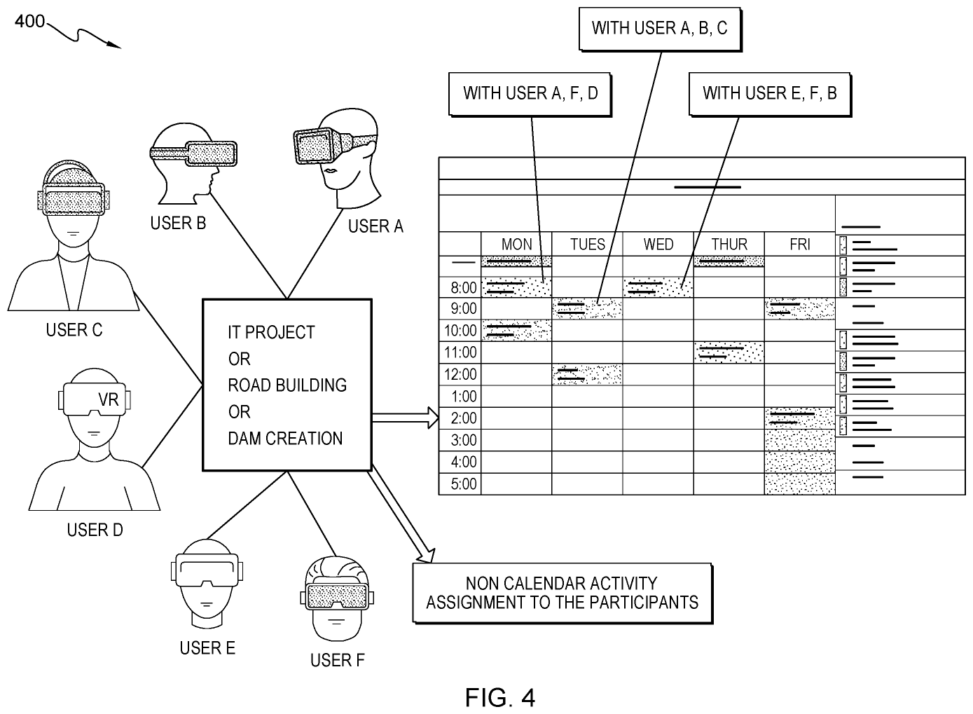

FIG. 4 is an exemplary diagram 400 of the program 104 transmitting a calendar invitation to another computing device associated with a different user based on identified contextual factors of a generated virtual environment. In this embodiment, there are six users (e.g., user A, user B, user C, user D, user E, and user F) within a generated virtual environment simulating a meeting. Examples of this meeting are a group project, a road building presentation, and a dam creation planning meeting. In this embodiment, user A and user B are navigating simulated virtual reality content associated with the future activity associated with the generated virtual environment. In this embodiment, the program 104 generates a calendar invitation for user A, user F and user D for future activity associated with the group project. In this embodiment, the program 104 generates a calendar invitation for user A, user B, and User C for the future activity associated with the road building presentation. In this embodiment, the program 104 generates a calendar invitation for user E, user F, and user B for the future activity associated with the dam creating planning meeting. In this embodiment, the program 104 generates calendar invitation for future activities for a different user in the plurality of users not currently within the generated virtual environment.

In another embodiment, the program 104 generates a calendar for each user in a plurality of users within the generated virtual environment. In this embodiment, each user is associated with a different computing device 102 associated with a different user. In another embodiment, the program 104 generates a calendar for each user based on the interaction of each user within the generated virtual environment. In this embodiment, the program 104 transmits calendar invitations detailing the participates, time, and description of a future activity.

FIG. 5 depicts a block diagram of components of computing systems within a computing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

A computer system 500 includes a communications fabric 502, which provides communications between a cache 516, a memory 506, a persistent storage 508, a communications unit 512, and an input/output (I/O) interface(s) 514. The communications fabric 502 can be implemented with any architecture designed for passing data and/or control information between processors (such as microprocessors, communications and network processors, etc.), system memory, peripheral devices, and any other hardware components within a system. For example, the communications fabric 502 can be implemented with one or more buses or a crossbar switch.

The memory 506 and the persistent storage 508 are computer readable storage media. In this embodiment, the memory 506 includes random access memory (RAM). In general, the memory 506 can include any suitable volatile or non-volatile computer readable storage media. The cache 516 is a fast memory that enhances the performance of the computer processor(s) 504 by holding recently accessed data, and data near accessed data, from the memory 506.

The program 104 may be stored in the persistent storage 508 and in the memory 506 for execution by one or more of the respective computer processors 504 via the cache 516. In an embodiment, the persistent storage 508 includes a magnetic hard disk drive. Alternatively, or in addition to a magnetic hard disk drive, the persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by the persistent storage 508 may also be removable. For example, a removable hard drive may be used for the persistent storage 508. Other examples include optical and magnetic disks, thumb drives, and smart cards that are inserted into a drive for transfer onto another computer readable storage medium that is also part of the persistent storage 508.

The communications unit 512, in these examples, provides for communications with other data processing systems or devices. In these examples, the communications unit 512 includes one or more network interface cards. The communications unit 512 may provide communications through the use of either or both physical and wireless communications links. The program 104 may be downloaded to the persistent storage 508 through the communications unit 512.

The I/O interface(s) 514 allows for input and output of data with other devices that may be connected to a mobile device, an approval device, and/or the server computing device 108. For example, the I/O interface 514 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., the program 104, can be stored on such portable computer readable storage media and can be loaded onto the persistent storage 508 via the I/O interface(s) 514. The I/O interface(s) 514 also connect to a display 522.

The display 522 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method comprising:
receiving an identification of a planned future meeting where a first participant will be participating;
generating a virtual environment to simulate the planned future meeting;
simulating the planned future meeting with a plurality of users within the generated virtual environment, with the first plurality of users including the first participant;
assessing an interaction pattern for the simulation of the planned future meeting;
determining a first deficiency associated with the first participant in the interaction pattern of the simulation of the planned future meeting;
determining a first remedial activity that can help the first participant address the first deficiency, with the first remedial activity occurring prior to the planned future meeting; and
generating a calendar invitation for the first participant for the first remedial activity that can help the first participant address the deficiency in the interaction pattern of the simulation of the planned future meeting before the planned future meeting occurs.

2. The computer-implemented method of claim 1 wherein the plurality of users further includes a second participant of the planned future meeting, the computer-implemented method further comprising:
determining a second deficiency associated with the second participant in the interaction pattern of the simulation of the planned future meeting;
determining a second remedial activity that can help the second participant address the second deficiency, with the second remedial activity occurring prior to the planned future meeting; and
generating a calendar invitation for the second participant for the second remedial activity that can help the second participant address the deficiency in the interaction pattern of the simulation of the planned future meeting before the planned future meeting occurs.

3-20. (canceled)
